(19) United States
(12) Patent Application Publication
(10) Pub. No.: US 2003/0097435 A1
(43) Pub. Date: May 22, 2003

(54) System and method for statistically processing messages

(76) Inventors: Eun-Jung Kwon, Daejeon (KR); O-Hyung Kwon, Daejeon (KR); Chieteuk Ahn, Daejeon (KR)

Correspondence Address: JACOBSON HOLMAN PLLC, 400 SEVENTH STREET N.W., SUITE 600, WASHINGTON, DC, 20004, US

(21) Appl. No.: 10/029,942

(22) Filed: Dec. 31, 2001

(30) Foreign Application Priority Data
Nov. 16, 2001 (KR) 2001-71306

(51) Int. Cl. G06F 15/173

(52) U.S. Cl. 709/223

(57) ABSTRACT

Disclosed is a system for statistically processing messages which comprises: a message compiler for compiling upstream and downstream messages of a network controller; a database for storing data; a message storage unit for storing the messages in the database when an amount of the messages compiled in the message compiler reaches a predetermined level; a statistical function handler for performing statistical processes on the messages stored in the database according to functions designated by a user; and a statistical result value storage unit for converting the results from the processes performed by the statistical function handler into a file of a predetermined format, then storing the file as a target table in the database.

### BACKGROUND OF THE INVENTION

(a) Field of the Invention

The present invention relates to CATV broadcasting. More particularly, the present invention relates to a system and method for statistically processing messages for obtaining an interruption rate during message transmission and reception, downstream and upstream message rates, and transmission and reception message distribution for each receiver by inserting a POD (point of deployment) into a cable television receiver, which is a receiver authentication process, and by compiling message transmissions of operations occurring while service is provided from a Headend to a receiver and message passing transmitted from the receiver to the Headend.

(b) Description of the Related Art

In the prior art, the flow of messages between interlinked networks is performed by using a non-volatile memory of network equipment such as an exchange router, which realizes connections between networks, and a network management system to classify messages flowing between networks such that when an interruption occurs, messages that are not transmitted or received are recovered automatically (i.e., without operator manipulation), after which the messages are again transmitted. Although a method is used in which, after service contents of transmitted and received messages are stored in non-volatile memory, corresponding contents are recovered during system recovery, such a method is excessively dependent on non-volatile memory. As a result, in the case where there is damage to the contents in memory, the prior art method is not an efficient way to ensure continuity of the service. To improve the above method, a network management system is proposed in which contents stored in non-volatile memory of network equipment is read in real-time to analyze and recover the message type. Such a system is disclosed in Korean Laid-open Patent Publication No. 2001-58764.

In such a network management system, it is necessary that there be provided a data analysis function performed through statistical processing. In order to improve the performance of the prior art network management system, after data from a table that records messages is read into temporary memory of a database, statistical processing of compiled messages is performed by extracting data as a string type (regardless of which type the data are originally) using dynamic memory pointers of a linked list. Subsequently, the extracted data are stored in a manner unrelated to table structure, then SQL (structured query language) results stored in the temporary memory are extracted to generate a text-based file, and statistical results are stored in the table using a text file input method provided by the database. A structure of such a prior art dynamic data statistics mechanism is shown in FIG. 1.

FIG. 1 is a schematic view of a structure of a conventional dynamic data statistics mechanism.

With reference to FIG. 1, in a conventional data statistics mechanism for improving performance, an original table name is read from a table information table 16 in a predetermined condition, and data of an original table 14 for performing statistical analysis are read. The read statistical data are stored in a dynamic temporary memory 13 of a database. At this time, the stored data are unrelated to table structure.

A dynamic memory 15 may be automatically allocated and deleted according to table structure. After data are stored in the dynamic memory 15, data stored in the dynamic temporary memory 13 are output to a text file 17 in a form capable of storage in the database, in order to use a text file storage function provided in the database.

However, in the above conventional processes, since output is performed in a text file format (DATA1|DATA2|DATA3 . . . ) for storage in the database without consideration of table structure (number of columns, column type), there is no way to know column names and column types corresponding to result values of questions, and result values of SQL sentences for performing statistical processes are stored using only delimiters. In such a method, even with an increase in performance that can be expected during statistics processing using batch transactions, precise storage of statistical result values in a target table 18 is uncertain compared to a method of the present invention, and the generated text file may only be used as material for storage in the target table 18.

Another network management system is disclosed in U.S. Pat. No. 5,987,513. In this network management system, to allow for remote network management, a Java applet is operated in a web browser and the Java applet is run in a local system (a system remotely connected to the network management system for network management). However, the responsibility of running the applet is given to a local computer, and network management and monitoring may only be performed by a single interface provided by the network management server, such that use of the system is inconvenient.

### SUMMARY OF THE INVENTION

The present invention has been made in an effort to solve the above problems.

It is an object of the present invention to provide a system and method for processing message statistics, in which downstream messages and upstream messages flowing through a network controller connected between an IP network and a cable network are generated as a target file in an extensible markup language (XML) format that takes into consideration real data structure, and statistical data result values are stored as the target file through individual elements parsing to see target table values, so that statistical results can be known.

To achieve the above object, the present invention provides a system and method for processing message statistics. The system comprises a message compiler for compiling upstream and downstream messages of a network controller; a database for storing data; a message storage unit for storing the messages in the database when an amount of the messages compiled in the message compiler reaches a predetermined level; a statistical function handler for performing statistical processes on the messages stored in the database according to functions designated by a user; and a statistical result value storage unit for converting the results from the processes performed by the statistical function handler into a file of a predetermined format, then storing the file as a target table in the database.

The method comprises: compiling messages transmitted and received through the network controller, separating the compiled messages into downstream and upstream messages, and performing storage by converting into a database format according to the divided items; performing statistical processes according to statistical processing function execution periods established through an administrator interface based on the stored data, and storing results of the processes in a memory; generating a file in a structural document format so as to fit the results file generated for statistical processes to the administrator's viewpoint while a data structure of an original table is maintained, and thereby storing the data stored in the memory in a target table; and parsing a file expressing generated statistical result data and storing values corresponding to elements as a target table.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a schematic view of a structure of a conventional dynamic data statistics mechanism;

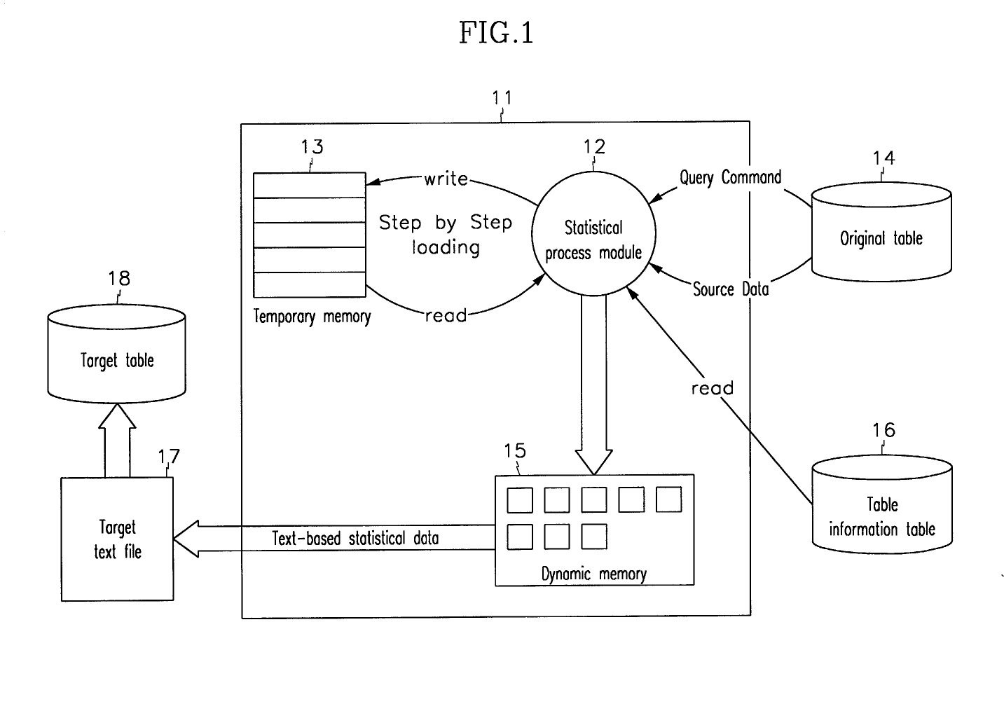

FIG. 2 is a drawing used to describe concepts behind the application of a system for processing message statistics to a cable broadcasting system according to a preferred embodiment of the present invention;

FIG. 3 is a block diagram of a system for processing message statistics according to a preferred embodiment of the present invention;

FIG. 4 is a flow chart of a method for processing message statistics according to a preferred embodiment of the present invention;

FIG. 5 is a drawing showing data of an original table;

FIG. 6 is a drawing showing data selected from an original table for running statistical functions;

FIG. 7 is a drawing showing a structure of result values stored in a main memory following the running of statistical functions;

FIG. 8 is a drawing showing results of converting statistical result values into an XML document in a main memory; and

FIG. 9 is a drawing showing XML-data schema rules illustrating the XML document of FIG. 8.

### DETAILED DESCRIPTION OF THE PREFERRED EMBODIMENTS

Preferred embodiments of the present invention will now be described in detail with reference to the accompanying drawings.

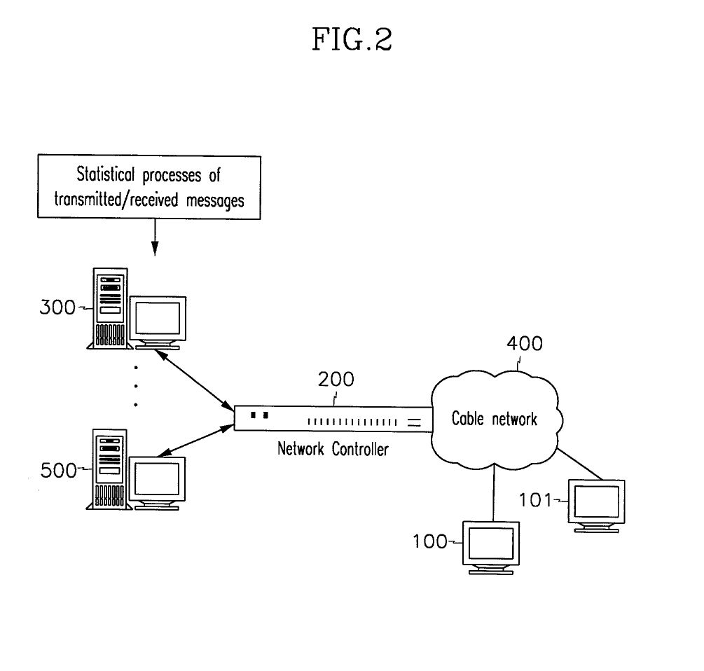

FIG. 2 is a drawing used to describe concepts behind the application of a system for processing message statistics to a cable broadcasting system according to a preferred embodiment of the present invention.

With reference to FIG. 2, a cable television provider offers various services to subscribers (100, 101, . . . ) using various application servers (500, 300, . . . ). The application servers (500, 300, . . . ) use a cable network 400 via a network controller 200.

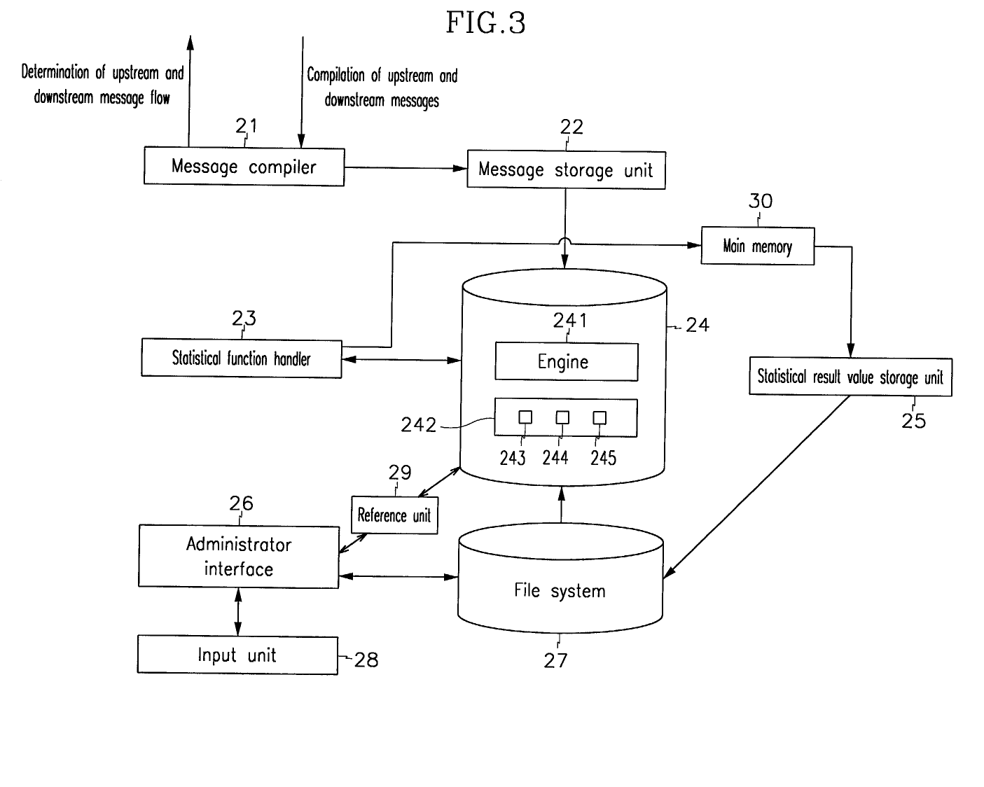

FIG. 3 is a block diagram of a system for processing message statistics according to a preferred embodiment of the present invention.

With reference to FIG. 3, a system for processing message statistics according to a preferred embodiment of the present invention includes a message compiler 21, a message storage unit 22, a statistical function handler 23, a main memory 30, a statistical result value storage unit 25, a database 24, a file system 27, an administrator interface 26, and an input unit 28.

The message compiler 21 compiles upstream and downstream messages of a network controller. The message storage unit 22 performs control to store the messages in the database 24 when an amount of the messages compiled in the message compiler 21 reaches a predetermined level. The database 24 stores data. Also, the statistical function handler 23 performs statistical processes on the messages stored in the database 24 according to functions designated by the user, and stores results from the processes in the main memory 30. The statistical result value storage unit 25 converts the results from the processes performed by the statistical function handler 23 into an XML file and then stores the file in the file system 27, after which the data is stored as a target table in the database 24. An operation of the system for processing message statistics structured as in the above will now be described in detail.

First, using the various application servers (500, 300, . . . ), the cable TV provider offers various services to the subscribers (100, 101, . . . ). At this time, the application servers (500, 300, . . . ) provide services by using the cable network 400 as a transmission path through control by the network controller 200. The network controller 200 controls the flow of messages between the subscribers (100, 101, . . . ) and the application servers (500, 300, . . . ).

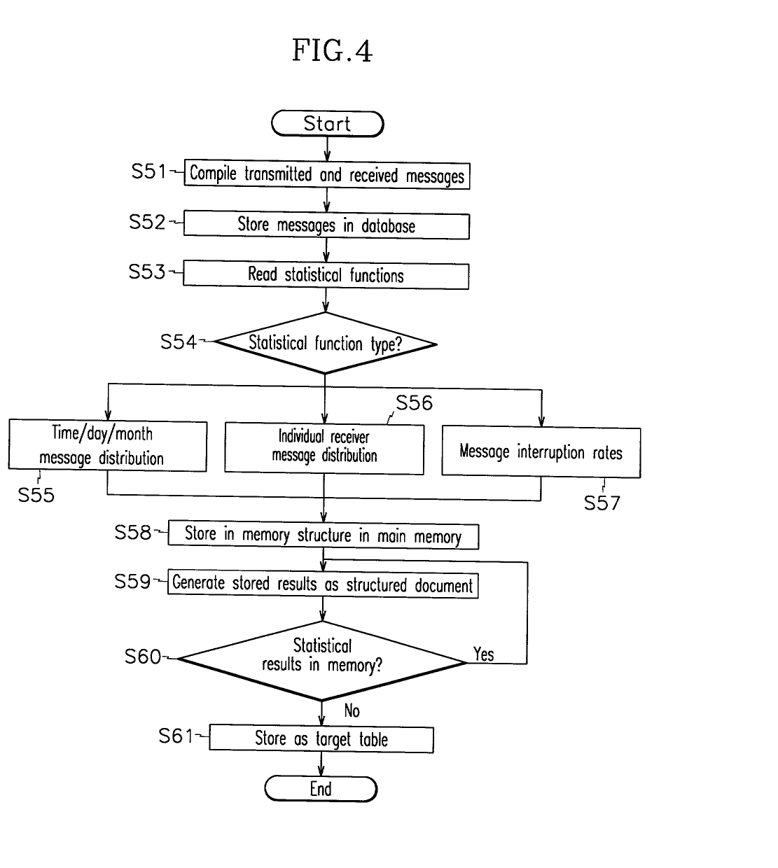

With reference also to FIG. 4, if messages are transmitted and received in this manner, the message compiler 21 compiles messages passing through the network controller 200 and between the subscribers (100, 101, . . . ) and head ends in step S51. Next, the message storage unit 22 stores the compiled messages in an original table 242 of the database 24 in predetermined period intervals in step S52. The Headend (i.e., cable head and antenna end) includes the application servers (500, 300, . . . ) and the network controller 200, and refers to all the equipment needed to transmit channel services to homes of the subscribers (100, 101, . . . ).

Using the stored messages, the statistical function handler 23 performs statistical processing according to times designated by the administrator. The statistical processing includes message distribution, message distribution for individual receivers, message interruption rate, etc. To perform statistical processing, statistical functions input by the administrator are read in step S53.

The statistical function handler 23 performs statistical processing according to the read statistical functions. In more detail, the statistical processing is performed according to whether the statistical functions are those related to time/day/month message distribution in step S55, related to message distribution for individual receivers in step S56, or related to message interruption rates in step S57.

Results of the statistical processing are stored in the main memory 30 in a predetermined memory structure in step S58. That is, the statistical function handler 23 calls calculation functions according to calculation intervals of statistical data, and stores column names, column type, and real data in accordance with the table structure in a buffer of the main memory 30 using dynamic memory pointers of a linked list.

Next, the stored results are generated as a structured document in an XML format with consideration of the structure of the real data, and they are stored in the file system 27 by the statistical result value storage unit 25 in step S59. This process is repeated until contents of the buffer of the main memory 30 are deleted in step S60. At the same time, if a node representing the real data stored in the main memory 30 is expressed as an XML document, the node is destroyed in the main memory 30.

Following the above, the statistical result value storage unit 25 stores the XML file stored in the file system 27 as a target table 243. With the expressing of the real data and storing the same as a target table by taking into consideration of column and data type, data is not lost and an XSL (XML Stylesheet Language) document is applied according to the administrator viewpoint such that in addition to storage as a target table, transmitted and received statistical data of messages may be monitored remotely through a web browser.

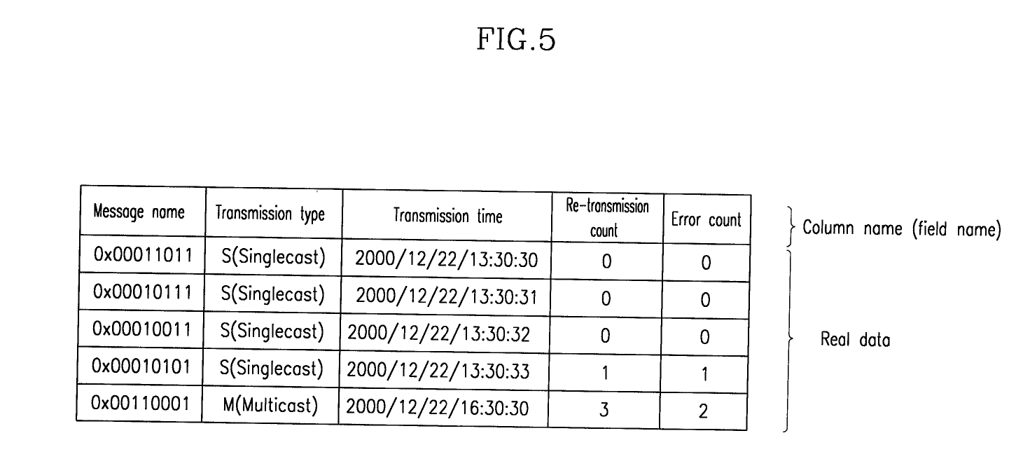

A data format during the process of converting data of the original table to a target table will be described in detail with reference to FIGS. 5-8.

FIG. 5 is an example of an original table. Real data of ‘0×000100001’ corresponding to msg_name column is a receiver authentication message transmitted upstream, the last 4 bits indicate a subscriber set-top box (HOST), and ‘0×00110001’ is a paid viewing history upload request message transmitted downstream.

Further, a related database is able to designate a column name (field name) to store data, and designate a corresponding data type (letters, numbers, date, etc.).

A data type with respect the above original table column name is as follows.

1. Message name: int (numbers, size: 4 bytes)

2. Transfer type: char (letters, size: 1 byte)

3. Transfer time: date

4. Re-try count: int (numbers, size: 4 bytes)

5. Error count: char (letters, size: 1 byte)

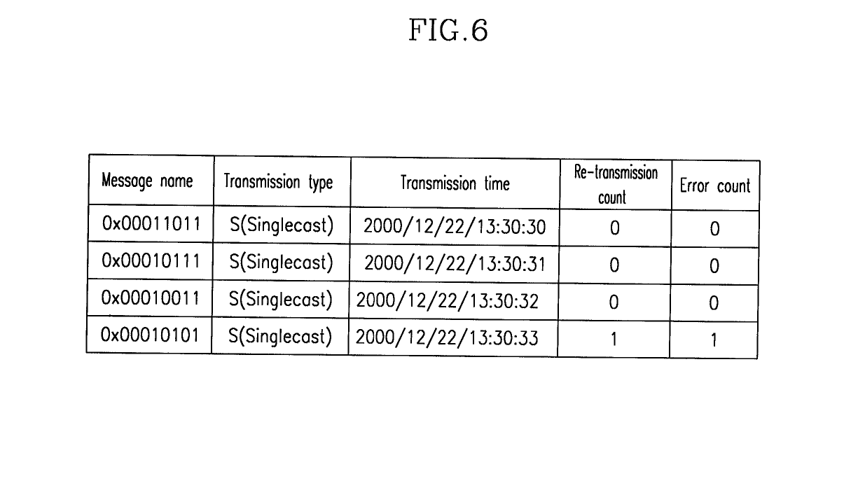

The format for such an original table stored in main memory is shown in FIG. 6. If it is assumed that the statistical functions are executed at midnight (24:00) to determine the frequency of errors in the upstream messages generated on a particular day (2000/12/22), the statistical function handler executes SQL sentences to approximate data executed at midnight on the present day and stored in the original table.

At this time, the SQL sentence approximating the database is ‘select msg_name, trans type, transfer_time, retry_count, error_count from original table where msg name like 0×0001% and transfer_time like 2000/12/12%’. The result values are selected from the original table of FIG. 6.

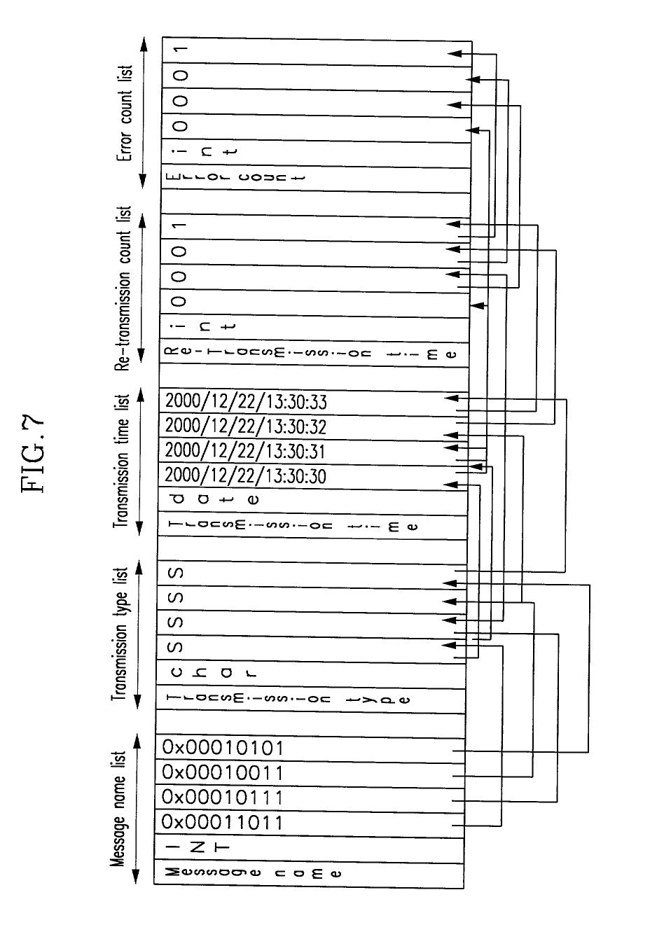

The linked list format by which the column name, column type, and actual data are stored in the main memory 30 is shown in FIG. 7.

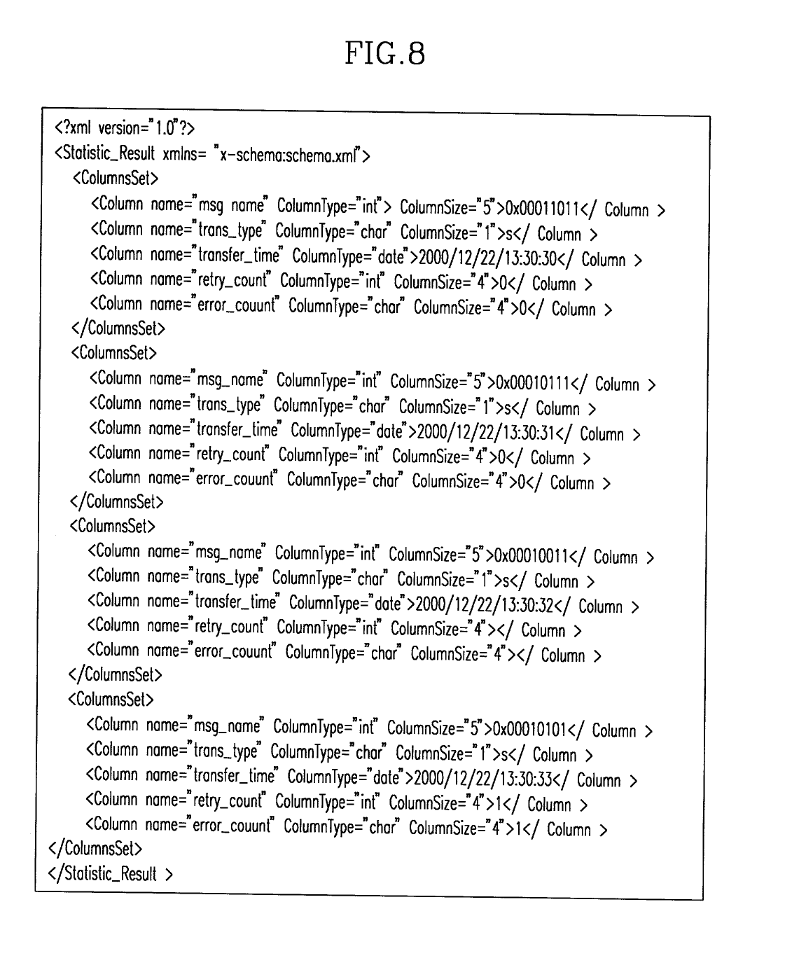

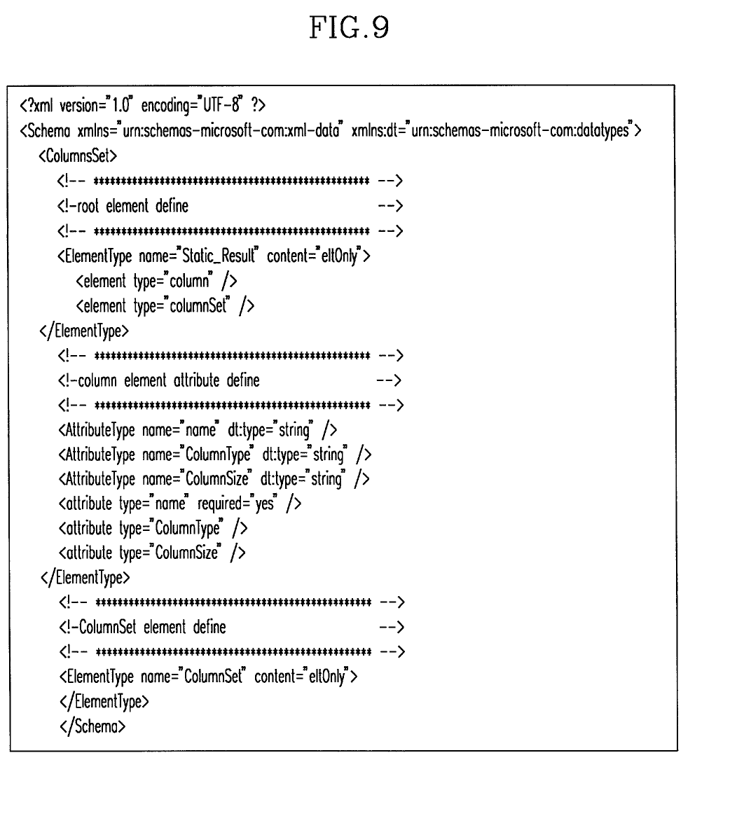

FIG. 7 is a drawing showing a structure of result values stored in the main memory 30 following the running of the statistical functions. If the result values stored in this manner in the main memory 30 are generated as an XML, a format as shown in FIG. 8 results. Referring to FIG. 8, text starting with “<” and ending with “>” is referred to as elements, and an XML-Data schema (file name: schema.xml) of FIG. 9 is declared as an XML document definition, which may be designated as column name, column type constraints through “<Static_Result xmlns=“x-schema:schema.xml”>” with reference to the schema.xml file of FIG. 9.

FIG. 8 is a drawing showing results of converting statistical result values stored in the main memory 30 into an XML document. When the statistical result values stored in the main memory 30 are generated into an XML document with consideration of the column name, data type and real data, precise real data corresponding to the column name during storage as a target table can be stored. The generated XML document allows for the monitoring of statistical data from various angles by adding only a display format according to administrator viewpoint with the application of an XSL document. That is, through the XML document, which is generated to store the statistical data values as a target table without going through the target table, the administrator may monitor message statistics.

Before generating the XML document, the syntax of elements forming the XML document must be known. In the present invention, XML-Data, which is able to designate a data type and constraints of the elements of the XML documents, is declared as shown in FIG. 9. XML-Data is a schema language for diversifying DTD (document type definition) functions, which designate existing XML documents.

When the statistical result values generated as XML are stored as a target table, since it is possible to know the value of real data corresponding to a column name, and the real data has structural constraints of documents (not only having real data but constraints corresponding to column names and a matching structure of real data), monitoring may be performed by applying the XSL document and without directly accessing the target table. Also, if data is stored as a target table when executing the statistical functions, the data of the original table is erased. At this time, the generated XML document may also be used as log data.

In addition, since an administrator interface using a web browser is possible, an administrator having access authority may monitor statistical result values recorded as an XML document at any location.

In the present invention described above, data is extracted for statistical calculations of transmitted and received messages that are compiled through an execution environment, in which an administrator may determine an execution interval, and statistical processing is performing in which structural characteristics of a table are kept intact. Also, storage operations of the calculated statistical values are separated to improve system performance. In particular, result values extracted and calculated from an original table may be expressed as an XML document using an XML-Data schema, which is an XML schema presentation format that can designate data type. Accordingly, when storing data, result values can be stored as a target table with no loss of data, and the XML document generated by result values calculated by applying various XSLs according to administrator viewpoint may be monitored through a web browser and without access through the database.

Also, in the present invention, for statistical processing of the compiled messages, since extraction and storage are separated between a data extraction time and statistical result storage time interval to perform database transaction processing, the processing load of the system is reduced, and loss of data can be prevented when statistical process result data generated in the data extraction and storage interval are generated in a structural document form to perform statistical data database storage.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. A system for statistically processing messages comprising:
a message compiler for compiling upstream and downstream messages of a network controller;
a database for storing data;
a message storage unit for storing the messages in the database when an amount of the messages compiled in the message compiler reaches a predetermined level;
a statistical function handler for performing statistical processes on the messages stored in the database according to functions designated by a user; and
a statistical result value storage unit for converting the results from the processes performed by the statistical function handler into a file of a predetermined format, then storing the file as a target table in the database.

2. The system of claim 1 wherein the file of a predetermined format is a is structural document format of an extensible markup language (XML) file.

3. The system of claim 1 further comprising a main memory in which results of the statistical processes performed by the statistical function handler are stored.

4. The system of claim 1 wherein the message storage unit, if the amount of messages compiled in the message compiler reaches the predetermined level, divides the compiled messages into downstream and upstream messages and performs storage by converting them into a database format according to the division.

5. The system of claim 2 further comprising a file system for storing the XML file generated in the statistical result value storage unit.

6. The system of claim 5 further comprising:
an input unit for receiving user input;
an administrator interface enabling monitoring of the target table stored in the database and the XML file stored in the file system according to user input; and
a reference unit for executing data of the target table stored in the database to allow monitoring by the user.

7. A method for statistically processing messages transmitted and received between a Headend, including a network controller for controlling network paths, for providing cable broadcasting and a receiver connected to the Headend through a cable network, the method comprising:
compiling messages transmitted and received through the network controller, separating the compiled messages into downstream and upstream messages, and performing storage by converting into a database format according to the divided items;
performing statistical processes according to statistical processing function execution periods established through an administrator interface based on the stored data, and storing results of the processes in a memory;
generating a file in a structural document format so as to fit the results file generated for statistical processes to the administrator's viewpoint while a data structure of an original table is maintained, and thereby storing the data stored in the memory in a target table; and
parsing a file expressing generated statistical result data and storing values corresponding to elements as a target table.

8. The method of claim 7 further comprising monitoring an XML file of the generated structural document format to check statistical results.

9. The method of claim 7 further comprising executing the generated target table using a predetermined program to monitor statistical results.

10. The method of claim 7 wherein the structural document format is an XML file structure.
